(19) United States
(12) Patent Application Publication
(10) Pub. No.: US 2026/0094165 A1
(43) Pub. Date: Apr. 2, 2026

(54) BRIDGING DIGITAL CURRENCIES INTO ENTERPRISE RESOURCE PLANNING (ERP) SYSTEMS

(71) Applicant: SAP SE, Walldorf (DE)

(72) Inventors: Stefan SCHMID, Rauenberg (DE); Sissi Ruthe, Hamburg (DE); Stefan Arnold, Leimen (DE); Bjoern Eike, Dossenheim (DE); Brit Panzer, Mannheim (DE); Bernhard Schweizer, Nußloch (DE)

(21) Appl. No.: 18/901,059

(22) Filed: Sep. 30, 2024

(51) Int. Cl. G06Q 20/42; G06Q 20/38

(52) U.S. Cl. CPC G06Q 20/42; G06Q 20/381

(57) ABSTRACT

Embodiments are described for a digital currency hub (DCH) comprising a memory and a processor. The processor is configured to receive a payment request from an enterprise resource planning (ERP) system and determine a first cryptocurrency, a cryptocurrency network, and a wallet address. The payment request indicates a first amount in a fiat currency. The processor is further configured to determine a first amount and transmit a payment command to the cryptocurrency network indicating the first cryptocurrency, the first amount, and the wallet address. The processor is further configured to receive a payment confirmation and generate a first account statement indicating the first amount and a business partner. The ERP system uses entities and processes, such as a fiat currency, accounts, business partners, and account statements, to communicate with the DCH. The DCH takes care to translate the entities and processes so that payments can be executed via crypto networks.

### BACKGROUND

An enterprise resource planning (ERP) system may be configured to send and/or receive payments to a business partner via banks or other financial institutions. In some embodiments, the business partner or a company that uses the ERP system may prefer the payments to be in a cryptocurrency, either a stable coin such as USDC or USDT, or a native currency such as bitcoin or ether. However, it is challenging for the ERP system to initiate and process payments in a cryptocurrency because the ERP system may not be compatible with sending and/or receiving cryptocurrencies.

### SUMMARY

Some embodiments of this disclosure include apparatuses and methods for enabling an enterprise resource planning (ERP) system to perform transactions in digital currencies, and more specifically, providing a transition layer to connect the ERP system with a cryptocurrency network.

Some embodiments of this disclosure relate to a digital currency hub (DCH) comprising a memory and at least one processor coupled to the memory. The at least one processor is configured to receive a payment request from an enterprise resource planning (ERP) system and determine a first cryptocurrency, a cryptocurrency network, and a wallet address based on the payment request. The payment request indicates a first amount in a fiat currency. The at least one processor is further configured to determine a first amount in the first cryptocurrency based on the first amount in the fiat currency and transmit a payment command to the cryptocurrency network. The payment command indicates the first cryptocurrency, the first amount in the first cryptocurrency, and the wallet address. The at least one processor is further configured to receive a payment confirmation of successful payment from the cryptocurrency network.

Some embodiments of this disclosure relate to a method for a digital currency hub (DCH). The method includes receiving a payment request from an enterprise resource planning (ERP) system and determining a first cryptocurrency, a cryptocurrency network, and a wallet address based on the payment request. The payment request indicates a first amount in a fiat currency. The method further includes determining a first amount in the first cryptocurrency based on the first amount in the fiat currency and transmitting a payment command to the cryptocurrency network. The payment command indicates the first cryptocurrency, the first amount in the first cryptocurrency, and the wallet address. The method further includes receiving a payment confirmation of successful payment from the cryptocurrency network.

Some embodiments of this disclosure relate to a non-transitory computer-readable medium (CRM) including instructions to, upon execution of the instructions by one or more processors of a digital currency hub (DCH), cause the DCH to perform operations. The operations include receiving a payment request from an enterprise resource planning (ERP) system and determining a first cryptocurrency, a cryptocurrency network, and a wallet address based on the payment request. The payment request indicates a first amount in a fiat currency. The operations further include determining a first amount in the first cryptocurrency based on the first amount in the fiat currency and transmitting a payment command to the cryptocurrency network. The payment command indicates the first cryptocurrency. The operations further include receiving a payment confirmation of successful payment from the cryptocurrency network.

This Summary is provided merely for purposes of illustrating some embodiments to provide an understanding of the subject matter described herein. Accordingly, the above-described features are merely examples and should not be construed to narrow the scope or spirit of the subject matter in this disclosure. Other features, embodiments, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system including a digital currency hub (DCH), according to some embodiments of the disclosure.

FIG. 2 illustrates a block diagram of the DCH, according to some embodiments of the disclosure.

FIG. 3 illustrates an example method of enabling an enterprise resource planning (ERP) system to perform transactions in digital currencies, according to some embodiments of the disclosure.

FIG. 4 illustrates an example of connecting the ERP system with the DCH, according to some embodiments of the disclosure.

FIG. 5 illustrates an example method of sending payments using the DCH, according to embodiments of the disclosure.

FIG. 6 illustrates an example computer system for implementing some embodiments of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some embodiments of this disclosure include apparatus, system, computer program product, and method embodiments for enabling an enterprise resource planning (ERP) system to perform transactions in digital currencies.

In some embodiments, the ERP system can process payments via banks and/or other financial institutions. For example, the ERP system may receive an invoice from a business partner, such as a vendor, requesting a payment. The ERP system may validate the invoice against purchase orders or contracts and confirm an amount, date due, and other details in the invoice. Once the invoice is validated, the ERP system can check a payment preference of the business partner. In some embodiments, the payment preference is stored as master data in a memory of the ERP system. The payment preference may indicate a preferred way of payment and a preferred bank. For example, the preferred way of payment may include bank transfer, automated clearing house (ACH), wire transfer, or other payment methods. In some embodiments, the master data may also include a bank name, a bank account number, and other information of the business partner to receive the payment. The ERP system may then generate and send a bank file to the preferred bank. The bank file may include the amount, a payment time, which can be immediate or in the future, a payment method, the bank account number, and other information to complete the payment. The bank may process the payment according to the bank file and send back a confirmation of successful payment, typically within a bank account statement. Finally, the ERP system can notify the business partner that the payment was successful.

In some embodiments, a cryptocurrency network may also support payments. Unlike the banks, which are centralized systems, the cryptocurrency network is decentralized. To perform a payment, both sender and receiver need to have a digital wallet. For example, a digital wallet of the sender needs to have enough funds to pay and a digital wallet of the receiver needs to be able to receive funds in specific cryptocurrencies and networks. In some embodiments, the sender may initiate the payment by digitally signing it with a private key, specifying the receiver's digital wallet address, and an amount in a cryptocurrency. The sender may then broadcast the payment information to the cryptocurrency network and participants of the cryptocurrency network can verify and validate the payment. Finally, the payment is added to a new block of a blockchain of the cryptocurrency network and the payment is finalized.

In some embodiments, the ERP system is not capable of making payments using the cryptocurrency network directly. For example, as discussed above, making payments using the cryptocurrency network requires connecting to the cryptocurrency network, having a digital wallet, and knowledge of the receiver's digital wallet. However, the ERP system may be configured to connect with banks and financial institutions, not cryptocurrency networks. In addition, the ERP system may not have the required information to make payments using the cryptocurrency network directly. Finally, the ERP system may not be compatible with the cryptocurrency network. For example, the ERP system may be configured to process fiat currencies, such as dollars, which normally have 2 digits after the decimal point. In contrast, cryptocurrencies may have 19 or more digitals after the decimal point.

In some embodiments, a transitional layer can be used to bridge the gap between the ERP system and the cryptocurrency network. For example, the transitional layer can be a digital currency hub (DCH). In some embodiments, the ERP system may receive an invoice from the business partner and validate the invoice as discussed above. However, instead of sending the bank file to the preferred bank, the ERP system may determine that the business partner prefers payments in a cryptocurrency. For example, the master data of the ERP system may indicate that the business partner prefers the cryptocurrency. For another example, the master data may simply indicate that the payment is to be processed via the DCH. In either case, the ERP system can send a payment request to the DCH. The payment request may include information that is known to the ERP system, such as a name of the business partner and an amount in a fiat currency. Thus, the ERP system is not required to know or understand the cryptocurrency network. In some aspects, the fiat currency may include dollars.

In some embodiments, the DCH may also include master data, which indicates information of the business partner, such as a preferred cryptocurrency, a cryptocurrency network, a digital wallet address, and other information needed for payment. Thus, when the DCH receives the payment request, the DCH can retrieve the information of the business partner and initiate payment via the cryptocurrency network as discussed above. Furthermore, the DCH may receive a payment confirmation from the cryptocurrency network once the payment is complete. In some embodiments, the DCH may generate an account statement summarizing the payment. Finally, the DCH may transit the account statement to the ERP system, which can further notify the business partner. Note that the DCH acts for the ERP system similar as banks. As the ERP system is capable to communicate to banks, the ERP system can in a similar way use its capabilities to communicate with the DCH.

In some embodiments, the DCH may also receive a receiving confirmation from the cryptocurrency network. For example, the business partner may make payment in a cryptocurrency to the company using the cryptocurrency network. In such a case, the DCH can also generate an account statement containing a received payment and transmit it to the ERP system. In some embodiments, the receiving confirmation may indicate an amount in the cryptocurrency. Thus, the DCH can convert the amount in the cryptocurrency into an amount in a fiat currency, wherein the account statement indicates the amount in the fiat currency.

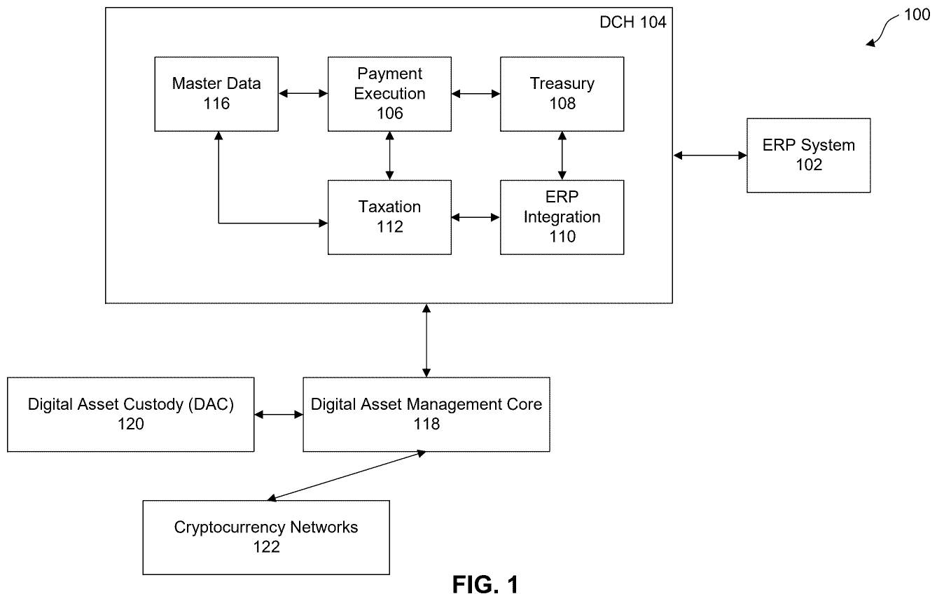

FIG. 1 illustrates an example system 100 including a DCH, according to some embodiments of the disclosure. The example system 100 is provided for the purpose of illustration only and does not limit the disclosed embodiments. The example system 100 may include, but is not limited to, an ERP system 102, a DCH 104, a digital asset management core 118, a digital asset custody (DAC) 120, and cryptocurrency networks 122. The DCH 104 may further include a payment execution 106, a treasury 108, an ERP integration 110, a taxation 112, and a master data 116, which are connected to each other. In some embodiments, the ERP system 102, the DCH 104, the digital asset management core 118, and the DAC 120 may include, but is not limited to, computer systems, servers, cloud systems, cloud servers, laptops, desktops, personal computers, databases, user equipment, and the like. In some embodiments, the DCH 104, the digital asset management core 118, and the DAC 120 may be integrated into a physical hardware. The physical hardware can be referred to as a combined DCH including the DCH 104, the digital asset management core 118, and the DAC 120.

In some embodiments, the ERP system 102 is a comprehensive software platform used by an organization, such as a company, to manage and integrate core business processes across various departments in real-time. For example, the ERP system 102 can process payments using centralized systems, such as banks and financial institutions, as discussed above. On the other hand, the cryptocurrency networks 122 are decentralized and can facilitate payment in a decentralized way as discussed above. In some embodiments, the DCH 104, coupled with the digital asset management core 118 and the DAC 120, can enable the ERP system 102 to process payment using the cryptocurrency networks 122.

In some embodiments, the master data 116 includes information of business partners of the organization that uses the ERP system 102. For example, the information may include a preferred method of payments, a cryptocurrency, a cryptocurrency network, and one or more digital wallet addresses. In such a case, when the DCH 104 receives a payment request corresponding to a business partner from the ERP system 102, the DCH 104 can look up the master data 116 to determine the information of the business partner. In some embodiments, the payment execution 106 can execute payments to and receive payments from the business partners. For example, the payment execution 106 can retrieve a digital wallet address, an amount in a cryptocurrency, and a cryptocurrency network from the master data 116. The payment execution 106 can then initiate a payment to the digital wallet address with the amount in the cryptocurrency via the cryptocurrency network and generate account statements containing confirmation of payments. In some embodiments, the treasury 108 can maintain a balance between incoming and outgoing funds so that there are enough funds to pay when needed. In some embodiments, the ERP integration 110 can enable communications with the ERP system 102. For example, the ERP integration 110 can convert document format of documents received from the ERP system 102, such as payment requests. For another example, the ERP integration 110 can convert document format of documents to be transmitted to the ERP system 102, such as account statements. In some embodiments, taxation 112 may generate statutory reporting to the organization or government entities

In some embodiments, the digital asset management core 118 may directly connect with the cryptocurrency networks 122. For example, the digital asset management core 118 may manage inventory of crypto assets and crypto transactions, such as digital wallets, transaction logs, transaction creation, approval & outbox, exchange links, and so on. In some embodiments, the digital asset management core 118 may broadcast payment information to participants of the cryptocurrency networks 122 so that the payment is complete and the payment information is added to a new block. In some embodiments, the DAC 120 may perform private key management, transaction signing, and other functions of transaction in the cryptocurrency networks 122.

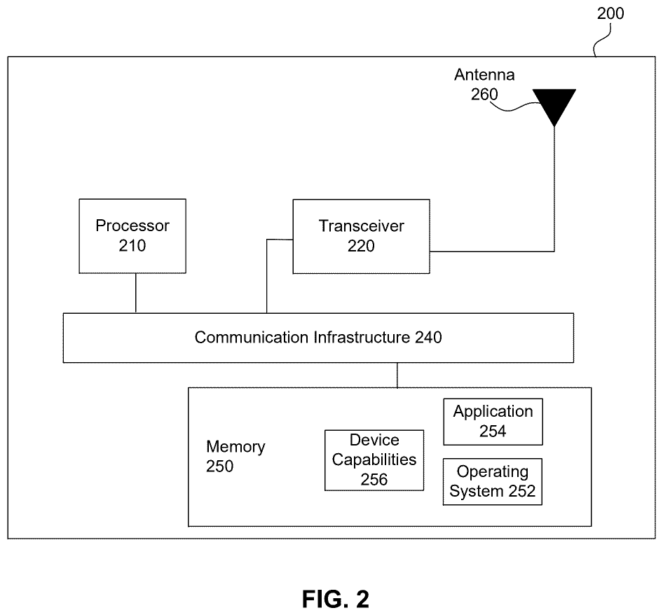

FIG. 2 illustrates a block diagram of the DCH, according to some embodiments of the disclosure. The electronic device 200 may be any of the electronic devices (e.g., the DCH 104, the digital asset management core 118, and the DAC 120, or a combination thereof of FIG. 1) of the system 100. The electronic device 200 includes a processor 210, one or more transceivers 220, a communication infrastructure 240, a memory 250, an operating system 252, an application 254, device capabilities 256, and antenna 260. Illustrated systems are provided as exemplary parts of electronic device 200, and electronic device 200 may include other circuit(s) and subsystem(s). Also, although the systems of electronic device 200 are illustrated as separate components, the embodiments of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the one or more transceivers 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the electronic device 200 and/or a user of the electronic device 200. In some embodiments, the device capabilities 256 may be stored in the memory 250.

The electronic device 200 may also include the communication infrastructure 240. The communication infrastructure 240 provides communication between, for example, the processor 210, the one or more transceivers 220, and the memory 250. In some implementations, the communication infrastructure 240 may be a bus.

The processor 210, alone, or together with instructions stored in the memory 250 performs operations enabling electronic device 200 of the system 100 to implement mechanisms for enabling an ERP system to perform transactions in digital currencies, as described herein. Alternatively, or additionally, the processor 210 can be “hard coded” to implement mechanisms for enabling an ERP system to perform transactions in digital currencies, as described herein.

The one or more transceivers 220 transmit and receive communications signals support mechanisms for enabling an ERP system to perform transactions in digital currencies. Additionally, the one or more transceivers 220 transmit and receive communications signals that support mechanisms for measuring communication link(s), generating and transmitting system information and data, and receiving the system information and data. According to some embodiments, the one or more transceivers 220 may be coupled to the antenna 260 to wirelessly transmit and receive the communication signals. The antenna 260 may include one or more antennas that may be the same or different types and can form one or more antenna ports. In some embodiments, the antenna 260 can be replaced or used in combination with wired communication interferences, such as Ethernet, Universal Serial Bus (USB), serial port, serial advanced technology attachment (SATA), and fiber optic interferences. The one or more transceivers 220 allow electronic device 200 to communicate with other devices that may be wired and/or wireless. In some examples, the one or more transceivers 220 may include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some embodiments of this disclosure, the one or more transceivers 220 may include a cellular subsystem, a WLAN subsystem, and/or a Bluetooth™ subsystem, each including its own radio transceiver and protocol(s) as will be understood by those skilled in the arts based on the discussion provided herein. In some implementations, the one or more transceivers 220 may include more or fewer systems for communicating with other devices.

In some examples, the one or more the transceivers 220 may include one or more circuits (including a WLAN transceiver) to enable connection(s) and communication over WLAN networks such as, but not limited to, networks based on standards described in IEEE 802.11.

Additionally, or alternatively, the one or more the transceivers 220 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 220 may include a Bluetooth™ transceiver. Additionally, the one or more the transceivers 220 may include one or more circuits (including a cellular transceiver) for connecting to and communicating on cellular networks.

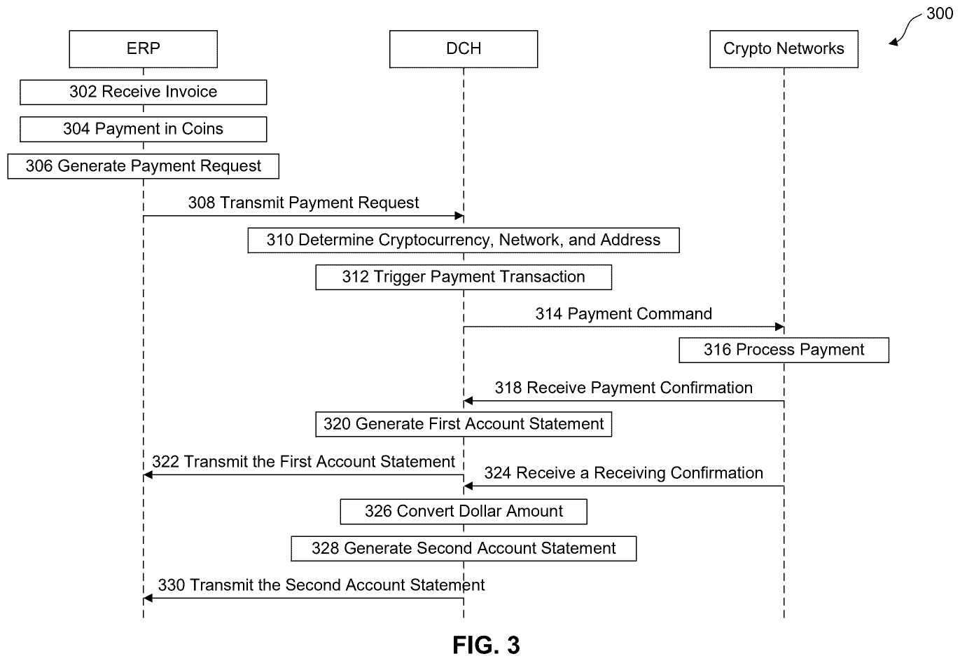

As discussed in more detail below with respect to FIGS. 3-6, processor 210 may implement different mechanisms for enabling an ERP system to perform transactions in digital currencies as discussed with respect to the system 100 of FIG. 1.

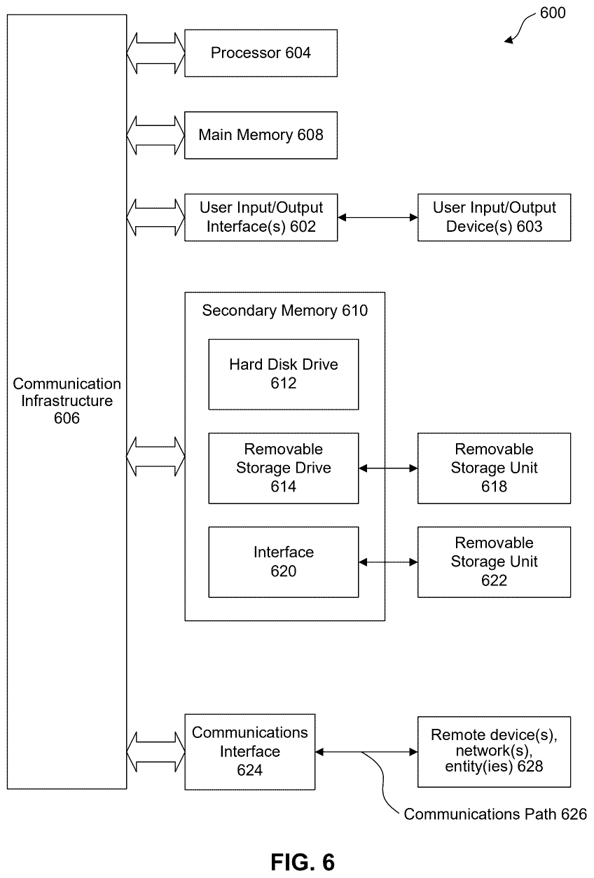

FIG. 3 illustrates an example method 300 of enabling an enterprise resource planning (ERP) system to perform transactions in digital currencies, according to some embodiments of the disclosure. As a convenience and not a limitation, FIG. 3 may be described with regard to elements of FIGS. 1, 2, and 6. The example method 300 may represent the operation of devices (e.g., the ERP system 102, the DCH 104, the digital asset management core 118, the DAC 120, the cryptocurrency networks 122, or a combination thereof of FIG. 1) enabling an ERP system to perform transactions in digital currencies. The example method 300 may also be performed by computer system 600 of FIG. 6. But the example method 300 is not limited to the specific embodiments depicted in those figures and other systems may be used to perform the method, as will be understood by those skilled in the art. It is to be appreciated that not all operations may be needed, and the operations may not be performed in the same order as shown in FIG. 3.

At 302, an ERP system, such as the ERP system 102, receives an invoice from a business partner. The invoice may indicate a first amount in a fiat currency, relevant products/services, and other information from the business partner. In some embodiments, the ERP system may validate the invoice. For example, the ERP system may compare the invoice with purchase orders or contracts to confirm the first amount in the fiat currency, a date due, and other details in the invoice. Once the invoice is validated, the control moves to 304

At 304, the ERP system may determine that the business partner prefers a payment in cryptocurrencies instead of fiat currencies. For example, the ERP system may include a first master data that indicate a payment preference of the business partner. In some embodiments, the first master data may indicate cryptocurrencies in general or a first cryptocurrency, such as USDT. In other embodiments, the first master data may just indicate that the payment is to be processed via a DCH, such as the DCH 104, without indicating cryptocurrencies. In either case, the control moves to 306.

At 306, the ERP system generates a payment request. If the first master data indicate the first cryptocurrency, the payment request may indicate the business partner, the first amount in the fiat currency, and the first cryptocurrency. On the other hand, if the first master data indicate the preference in cryptocurrencies in general or that the payment is to be processed via the DCH, the payment request may just indicate the business partner and the first amount in the fiat currency.

At 308, the ERP system transmits the payment request to the DCH. In some embodiments, an ERP integration, such as the ERP integration 110, may convert the payment request to a format that is compatible with the DCH 104.

At 310, the DCH may determine the first cryptocurrency, a cryptocurrency network, such as Ethereum, and a digital wallet address. For example, the DCH may include a second master data, which include information regarding the business partner. The information may indicate the first cryptocurrency, the cryptocurrency network, and the digital wallet address. Thus, the DCH may determine that the payment request is regarding the business partner and look up the information regarding the business partner from the second master data. In some embodiments, the payment request itself indicates the first cryptocurrency.

At 312, the DCH triggers a payment transaction. In some embodiments, the DCH may generate a payment command that indicates the first cryptocurrency, a first amount in the first cryptocurrency, and the digital wallet address. For example, the DCH can convert the first amount in the fiat currency to the first amount in the first cryptocurrency based an exchange rate between the fiat currency and the first cryptocurrency. In some aspects, the first cryptocurrency may be a stable coin for the fiat currency. In such a case, the exchange rate can be 1:1 and thus there is no need for conversion.

At 314, the DCH transmits the payment command to the cryptocurrency network. In some embodiments, the DCH transmits the payment command to a digital asset management core, such as the digital asset management core 118, which forwards the payment command to the cryptocurrency network. For example, the DCH may configure the digital asset management core to proceed the payment. The digital asset management core may broadcast information of the payment in the cryptocurrency network. For example, the information of the payment may indicate a digital wallet address of an organization of the ERP system, the digital wallet address of the business partner, the first amount in the first cryptocurrency.

At 316, the cryptocurrency network may process the payment. For example, participants of the cryptocurrency network can verify and validate the payment when receiving the information of the payment. In this way, the payment is added to a new block of a blockchain of the cryptocurrency network and the payment is finalized.

At 318, the cryptocurrency network may transmit a payment confirmation to the DCH. In some embodiments, the payment confirmation may indicate that the payment of the first amount in the first cryptocurrency to the digital wallet address of the business partner was successful. In addition, payment confirmation may also indicate a second amount in a second cryptocurrency. In some embodiments, the second amount in the second cryptocurrency is a cost of processing the payment in the cryptocurrency network. For example, the cryptocurrency network can be the Ethereum network and thus the second cryptocurrency can be ether (ETH) because the ETH is a native currency in the Ethereum network. In some embodiments, the first cryptocurrency is a stable cryptocurrency, such as the USDT, and the second cryptocurrency is a non-stable cryptocurrency, such as the ETH. Thus, in addition to the first amount in the first cryptocurrency that is equivalent to the first amount in the fiat currency, the organization may be required to pay the second amount in the second cryptocurrency as a transaction cost.

At 320, the DCH generates a first account statement. In some embodiments, the DCH converts the second amount in the second cryptocurrency to a third amount in the fiat currency representing the transaction cost in the fiat currency. The DCH may then determine a second amount in the fiat currency by adding the first amount in the fiat currency and the third amount in the fiat currency. In some embodiments, the first account statement may indicate the second amount in the fiat currency and the business partner. In other embodiments, the first account statement indicates the first amount in the fiat currency that pays the invoice without indicating the third amount in the fiat currency.

At 322, the DCH transmits the first account statement to the ERP. In some embodiments, the ERP may report that the payment requested in the invoice was successful.

At 324, the cryptocurrency network may transit a receiving confirmation to the DCH. In some embodiments, the receiving confirmation indicates that a payment of a fourth amount in the first cryptocurrency was received in the digital wallet of the organization of the ERP system. The receiving confirmation may also indicate that the payment was made by the business partner that sent the invoice at 302 or another business partner.

At 326, the DCH may convert the fourth amount in the first cryptocurrency to a fourth amount in the fiat currency.

At 328, the DCH may generate a second account statement. In some embodiments, the second account statement indicates that the fourth amount in the fiat currency has been received from the business partner or the other business partner.

At 330, the DCH transmits the second account statement to the ERP system. In some embodiments, the ERP system may report to the business partner or the other business partner that the payment of the fourth amount in the fiat currency was successfully received.

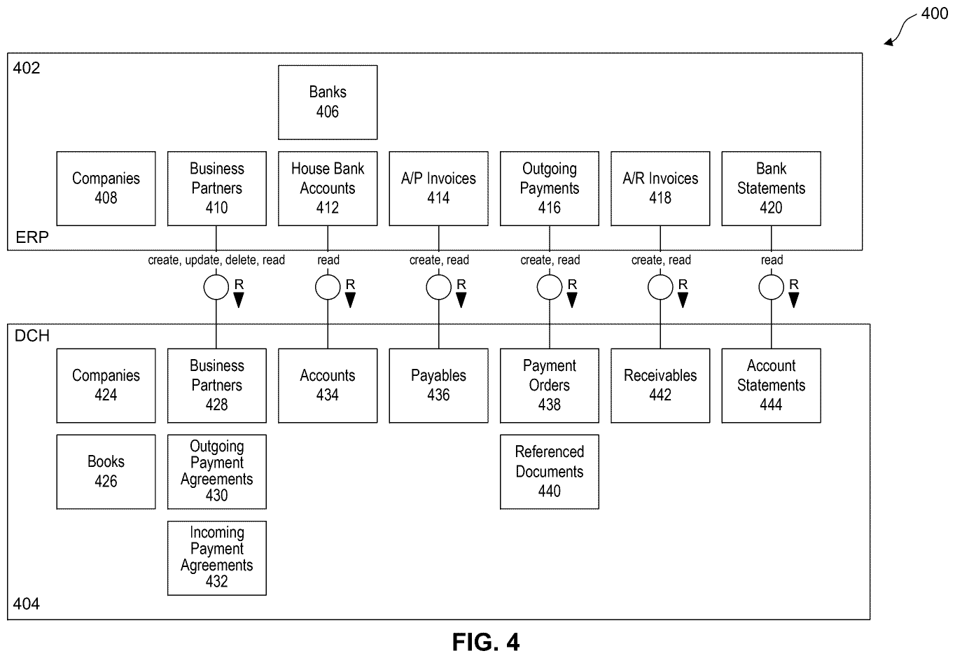

FIG. 4 illustrates an example 400 of connecting the ERP system with the DCH, according to some embodiments of the disclosure. As a convenience and not a limitation, FIG. 4 may be described with regard to elements of FIGS. 1, 2, and 6. The example 400 may represent the operation of devices (e.g., the ERP system 102, the DCH 104, the digital asset management core 118, the DAC 120, the cryptocurrency networks 122, or a combination thereof of FIG. 1) enabling the ERP system to perform transactions in digital currencies. The example 400 may also be performed by computer system 600 of FIG. 6. But the example 400 is not limited to the specific embodiments depicted in those figures and other systems may be used to perform the method, as will be understood by those skilled in the art. It is to be appreciated that not all operations may be needed, and the operations may not be performed in the same order as shown in FIG. 4.

In some embodiments, the example 400 includes an ERP system 402 and a DCH 404. The ERP system 402 may include companies 408, business partners 410, banks 406, house bank accounts 412, A/P invoices 414, outgoing payments 416, A/R invoices 418, and bank statement 420. The companies 408 include information of organizations using the ERP system. The business partners 410 include business partners of the organizations. For example, the business partners 410 may indicates that an organization may send funds to and receive funds from one or more business partners. The banks 406 may refer to external financial institutions that the organization uses to process financial transactions. Here, the banks 406 shown in the ERP system 402 may indicate connection points to the external financial institutions instead of the actual external financial institution. The house bank account 412 may represent the organization's internal accounts that are used for conducting day-to-day financial operations like making payments and receiving money. In some embodiments, the house bank account 412 may be linked to accounts in the external financial institutions represented by the banks 406. The A/P invoices 414 may be referred to as accounts payable invoices that process invoices received from business partners. The outgoing payments 416 processes payments to business partners. The A/R invoices 418 may also be referred to as accounts receivable invoices that process invoices issued by the organization to business partners. The bank statement 420 may process bank statements received from financial institutions or other parties, such as the DCH 404.

In some embodiments, the DCH 404 may include companies 424, books 426, business partners 428, outgoing payment agreements 430, incoming payment agreements 432, accounts 434, payables 436, payment orders 438, referenced documents 440, receivables 442, and account statements 444. Specifically, the companies 424 may include one or more organizations that use the DCH 404. The companies 424 may be the same as the companies 408 or be a subset of the companies 408. The books 426 may indicate financial situation of the companies 424. The business partners 428 may include one or more business partners of the one or more organizations. Similar to the companies 424, the business partners 428 may be the same as the business partners 410 or be a subset of the business partners 410. The outgoing payment agreement 430 indicates preferred methods of outgoing payments from the one or more organizations to business partners. For example, the preferred method of outgoing payments may indicate a cryptocurrency, a cryptocurrency network, the wallet address, and others. Similarly, the incoming payment agreement 432 indicates a preferred method of incoming payments to the one or more organizations from business partners. The accounts 434 indicates the balance and other information of accounts of organizations in one or more cryptocurrency networks. The payable 436 may show a subset of A/P Invoices that the ERP system has determined to be paid via DCH. Similarly, the receivable 442 may show a subset of A/R invoices that the ERP system has determined as to be paid in a digital currency. The payment orders 438 may process payment requests received from the ERP system 402 as discussed above. The referenced documents 440 include documents related to outgoing payments such as A/P invoices. The account statements 444 generate account statements to be send to the ERP system 402.

In some embodiments, the ERP system 402 connects with the DCH 404 at various points. For example, the business partners 410 may configure the business partners 428. Specifically, the business partners 410 may create, update, delete, and/or read business partners stored in the business partners 428. For another example, the house bank accounts 412 may read information from the accounts 434. For yet another example, the A/P invoice 414 may transmit invoices to the payables 436. For yet another example, the outgoing payments 416 may transmit information of orders to the payment orders 438. For yet another example, the A/R invoices 418 may transmit invoices to the receivables 442. For yet another example, the bank statements 420 may request account statements from the account statements 444.

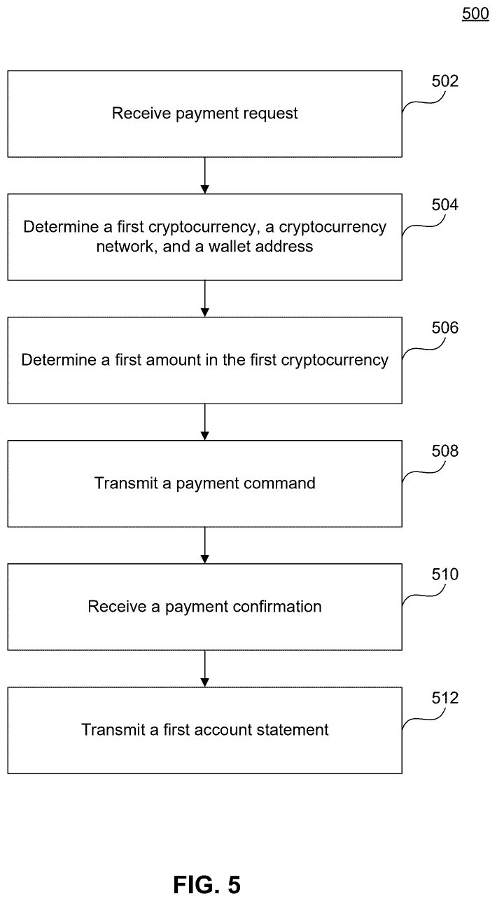

FIG. 5 illustrates an example method 500 of sending payments using the DCH, according to embodiments of the disclosure. As a convenience and not a limitation, FIG. 5 may be described with regard to elements of FIGS. 1, 2, and 6. The example method 500 may represent the operation of devices (e.g., the ERP system 102, the DCH 104, the digital asset management core 118, the DAC 120, the cryptocurrency networks 122, or a combination thereof of FIG. 1) enabling an ERP system to perform transactions in digital currencies. The example method 500 may also be performed by computer system 600 of FIG. 6. But the example method 500 is not limited to the specific embodiments depicted in those figures and other systems may be used to perform the method, as will be understood by those skilled in the art. It is to be appreciated that not all operations may be needed, and the operations may not be performed in the same order as shown in FIG. 5.

At 502, a DCH, such as the DCH 104, receives a payment request from an ERP system, such as the ERP system 102. The payment request indicates a first amount in a fiat currency

At 504, the DCH determines a first cryptocurrency, a cryptocurrency network, and a wallet address based on the payment request. In some embodiments, the DCH may determine a first business partner based on the payment request. The DCH then retrieves master data from a memory of the DCH, wherein the master data includes the first business partner. Finally, the DCH may determine that the first cryptocurrency, the cryptocurrency network, and the wallet address are associated with the first business partner in the master data.

At 506, the DCH determines a first amount in the first cryptocurrency. In some embodiments, the DCH may convert the first amount in the fiat currency to the first amount in the first cryptocurrency.

At 508, the DCH transmits a payment command to the cryptocurrency network. In some embodiments, the payment command indicates the first cryptocurrency, the first amount in the first cryptocurrency, and the wallet address.

At 510, the DCH receives a payment confirmation of successful payment from the cryptocurrency network. In some embodiments, the DCH may determine a second amount in the fiat currency based on the payment confirmation and generate a first account statement indicating the second amount in the fiat currency and the first business partner. In some embodiments, the DCH may determine a second amount in a second cryptocurrency, wherein the second cryptocurrency corresponds to the cryptocurrency network and convert the second amount in the second cryptocurrency to a third amount in the fiat currency. In some embodiments, the first cryptocurrency is a stable cryptocurrency and the second cryptocurrency is a non-stable cryptocurrency. The second amount in the second cryptocurrency may correspond to a network fee in the cryptocurrency network incurred by the payment command.

At 512, the DCH transmits the first account statement to the ERP system.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A digital currency hub (DCH), comprising:
a memory; and
at least one processor coupled to the memory and configured to:
receive a payment request from an enterprise resource planning (ERP) system, wherein the payment request indicates a first amount in a fiat currency to be paid to a first business partner;
determine a first cryptocurrency, a cryptocurrency network, and a wallet address based on the payment request;
determine a first amount in the first cryptocurrency based on the first amount in the fiat currency;
transmit a payment command to the cryptocurrency network, wherein the payment command indicates the first cryptocurrency, the first amount in the first cryptocurrency, and the wallet address; and
receive a payment confirmation of successful payment from the cryptocurrency network.

2. The DCH of claim 1, wherein to determine the first cryptocurrency, the cryptocurrency network, and the wallet address, the at least one processor is further configured to:
determine the first business partner based on the payment request;
retrieve master data from the memory, wherein the master data includes the first business partner; and
determine that the first cryptocurrency, the cryptocurrency network, and the wallet address are associated with the first business partner in the master data.

3. The DCH of claim 2, wherein the at least one processor is further configured to:
determine a second amount in the fiat currency based on the payment confirmation;
generate a first account statement indicating the second amount in the fiat currency and the first business partner; and
transmit the first account statement to the ERP system.

4. The DCH of claim 3, wherein to determine the second amount in the fiat currency, the at least one processor is further configured to:
determine a second amount in a second cryptocurrency, wherein the second cryptocurrency corresponds to a native currency of the cryptocurrency network;
convert the second amount in the second cryptocurrency to a third amount in the fiat currency; and
determine the second amount in the fiat currency by adding the first amount in the fiat currency and the third amount in the fiat currency.

5. The DCH of claim 4,
wherein the first cryptocurrency is a stable cryptocurrency, and
wherein the second cryptocurrency is a non-stable cryptocurrency.

6. The DCH of claim 5,
wherein the second amount in the second cryptocurrency corresponds to a network fee representing a transaction cost in the native currency of the cryptocurrency network incurred by the payment command.

7. The DCH of claim 1, wherein the at least one processor is further configured to:
receive a receiving confirmation from the cryptocurrency network, wherein the receiving confirmation indicates a fourth amount in the first cryptocurrency and a second business partner;
convert the fourth amount in the first cryptocurrency to a fourth amount in the fiat currency;
generate a second account statement indicating that the fourth amount in the fiat currency has been received from the second business partner; and
transmit the second account statement to the ERP system.

8. A computer-implemented method for a digital currency hub (DCH), comprising:
receiving a payment request from an enterprise resource planning (ERP) system, wherein the payment request indicates a first amount in a fiat currency;
determining a first cryptocurrency, a cryptocurrency network, and a wallet address based on the payment request;
determining a first amount in the first cryptocurrency based on the first amount in the fiat currency;
transmitting a payment command to the cryptocurrency network, wherein the payment command indicates the first cryptocurrency, the first amount in the first cryptocurrency, and the wallet address; and
receiving a payment confirmation of successful payment from the cryptocurrency network.

9. The computer-implemented method of claim 8, wherein the determining the first cryptocurrency, the cryptocurrency network, and the wallet address further comprises:
determining a first business partner based on the payment request;
retrieving master data from a memory, wherein the master data includes the first business partner; and
determining that the first cryptocurrency, the cryptocurrency network, and the wallet address are associated with the first business partner in the master data.

10. The computer-implemented method of claim 9, further comprising:
determining a second amount in the fiat currency based on the payment confirmation;
generating a first account statement indicating the second amount in the fiat currency and the first business partner; and
transmitting the first account statement to the ERP system.

11. The computer-implemented method of claim 10, wherein the determining the second amount in the fiat currency further comprises:
determining a second amount in a second cryptocurrency, wherein the second cryptocurrency corresponds to a native currency of the cryptocurrency network;
converting the second amount in the second cryptocurrency to a third amount in the fiat currency; and
determining the second amount in the fiat currency by adding the first amount in the fiat currency and the third amount in the fiat currency.

12. The computer-implemented method of claim 11,
wherein the first cryptocurrency is a stable cryptocurrency, and
wherein the second cryptocurrency is a non-stable cryptocurrency.

13. The computer-implemented method of claim 12, wherein the second amount in the second cryptocurrency corresponds to a network fee in the cryptocurrency network incurred by the payment command.

14. The computer-implemented method of claim 8, further comprising:
receiving a receiving confirmation from the cryptocurrency network, wherein the receiving confirmation indicates a fourth amount in the first cryptocurrency and a second business partner;
converting the fourth amount in the first cryptocurrency to a fourth amount in the fiat currency;
generating a second account statement indicating that the fourth amount in the fiat currency has been received from the second business partner; and
transmitting the second account statement to the ERP system.

15. A non-transitory computer-readable medium (CRM) comprising instructions to, upon execution of the instructions by one or more processors of a digital currency hub (DCH), cause the DCH to perform operations, the operations comprising:
receiving a payment request from an enterprise resource planning (ERP) system, wherein the payment request indicates a first amount in a fiat currency;
determining a first cryptocurrency, a cryptocurrency network, and a wallet address based on the payment request;
determining a first amount in the first cryptocurrency based on the first amount in the fiat currency;
transmitting a payment command to the cryptocurrency network, wherein the payment command indicates the first cryptocurrency, the first amount in the first cryptocurrency, and the wallet address; and
receiving a payment confirmation of successful payment from the cryptocurrency network.

16. The non-transitory CRM of claim 15, wherein the determining the first cryptocurrency, the cryptocurrency network, and the wallet address further comprises:
determining a first business partner based on the payment request;
retrieving master data from a memory, wherein the master data includes the first business partner; and
determining that the first cryptocurrency, the cryptocurrency network, and the wallet address are associated with the first business partner in the master data.

17. The non-transitory CRM of claim 16, wherein the operations further comprise:
determining a second amount in the fiat currency based on the payment confirmation;
generating a first account statement indicating the second amount in the fiat currency and the first business partner; and
transmitting the first account statement to the ERP system.

18. The non-transitory CRM of claim 17, wherein the determining the second amount in the fiat currency further comprises:
determining a second amount in a second cryptocurrency, wherein the second cryptocurrency corresponds to the cryptocurrency network;
converting the second amount in the second cryptocurrency to a third amount in the fiat currency; and
determining the second amount in the fiat currency by adding the first amount in the fiat currency and the third amount in the fiat currency.

19. The non-transitory CRM of claim 18,
wherein the first cryptocurrency is a stable cryptocurrency,
wherein the second cryptocurrency is a non-stable cryptocurrency, and
wherein the second amount in the second cryptocurrency corresponds to a network fee in the cryptocurrency network incurred by the payment command.

20. The non-transitory CRM of claim 15, wherein the operations further comprise:
receiving a receiving confirmation from the cryptocurrency network, wherein the receiving confirmation indicates a fourth amount in the first cryptocurrency and a second business partner;
converting the fourth amount in the first cryptocurrency to a fourth amount in the fiat currency;
generating a second account statement indicating that the fourth amount in the fiat currency has been received from the second business partner; and
transmitting the second account statement to the ERP system.
